(19) United States
(12) Patent Application Publication
(10) Pub. No.: US 2024/0313472 A1
(43) Pub. Date: Sep. 19, 2024

(54) CONNECTORS WITH UNIVERSAL COMPONENTS

(71) Applicant: Interplex Industries, Inc., East Providence, RI (US)

(72) Inventors: Robert Hennemuth, Franklin, MA (US); Lee Burgess, Foothill Ranch, CA (US)

(21) Appl. No.: 18/271,459

(22) PCT Filed: Jan. 12, 2022
(86) PCT No.: PCT/US2022/012103

§ 371 Date: Jul. 9, 2023

Related U.S. Application Data
(60) Provisional application No. 63/136,801, filed on Jan. 13, 2021.

(51) Int. Cl. H01R 13/627; H01R 13/428; H01R 13/625

(52) U.S. Cl. CPC H01R 13/6271; H01R 13/428; H01R 13/625

(57) ABSTRACT

A connector assembly for connecting together parts to convey movement of a medium, such as electric current. The connector assembly includes first and second connectors for connection to each other. The second connector has a core body with an inner chamber, within which a conveyance device is mounted. A fastener is at least partially supported on the core body. The fastener has an engagement portion moveable between an engaged position and a disengaged position to connect and disconnect the first and second connectors, respectively. A sleeve is disposed over the core body. The sleeve is linearly and angularly moveable to move the engagement portion of the fastener from the engaged position to the disengaged position. An actuator may be mounted to the sleeve and is also operable to move the engagement portion of the fastener from the engaged position to the disengaged position.

### CROSS-REFERENCE TO RELATED APPLICATION(S)

This application claims the benefit of priority under 35 U.S.C. § 119(e) to U.S. Provisional Patent Application No. 63/136,801 filed on 13 Jan. 2021, which is herein incorporated by reference.

### TECHNICAL FIELD

This disclosure relates generally to connectors for connecting together two parts to permit the movement of a medium therebetween, wherein the movement may be for the transfer of power, information and/or physical matter, and wherein the medium may be electrical, photonic, fluidic or mechanical.

### BACKGROUND

Connectors, such as plug-type connectors, are widely used to interconnect parts to permit mechanical motion, electric current, light or a fluid to be conveyed between the parts. Conventionally, a connector includes a first component that is engaged with a second component, such as a plug component being received in a receptacle component. A moveable latch is often used to releasably secure the first component to the second component. A release mechanism is typically used to move the latch and thereby release the first component from the second component. The construction of the latch and its release mechanism are often dependent on the application of the connector and can take different forms. For example, a latch may be released by a push-pull mechanism or a twist mechanism.

Conventionally, connectors with different latch and release mechanisms have completely different constructions. Thus, a connector with a push-pull release mechanism would have a completely different construction than a connector with a twist release mechanism. As such, a manufacturer of connectors must stock a unique set of components for each type of connector it makes. In order for a manufacturer to reduce its inventory of components, it would be desirable to have different types of connectors share as many components as possible. In addition to and/or in lieu of this, it would also be desirable for a connector to be capable of utilizing more than one type of release mechanism. The present disclosure is directed to such connectors and a method of producing the same.

### SUMMARY

In accordance with the disclosure, a connector assembly is provided for connecting together parts to convey movement of a medium between the parts. The connector assembly includes first and second connectors for connection to each other. The first connector includes a first conveyance device constructed to convey movement of the medium. The second connector includes a plug and a core body having an inner chamber. A second conveyance device is mounted in the chamber of the core body. The second conveyance device is constructed to convey movement of the medium and is configured for connection to the first conveyance device. A fastener is at least partially supported by the core body. The fastener has an engagement portion moveable between an engaged position and a disengaged position to connect and disconnect the first and second connectors, respectively. A sleeve is disposed over the core body. The sleeve is linearly moveable between first and second linear positions and is angularly moveable between first and second angular positions. Linear movement of the sleeve from the first linear position to the second linear position and angular movement of the sleeve from the first angular position to the second angular position moves the engagement portion of the fastener from the engaged position to the disengaged position.

### BRIEF DESCRIPTION OF THE DRAWINGS

The features, aspects, and advantages of the present invention will become better understood with regard to the following description, appended claims, and accompanying drawings where:

FIG. 1 shows a right side perspective view of a receptacle-type connector and a plug-type connector;

FIG. 2 shows an exploded view of the receptacle-type connector;

FIG. 3 shows an exploded view of the plug-type connector;

FIG. 4 shows a longitudinal sectional view of the plug-type connector;

FIG. 5 shows a perspective view of a spring structure of the plug-type connector;

FIG. 6 shows a partial perspective view of the plug-type connector with a plug removed to show a pair of the spring structures supported on a core body;

FIG. 7 shows a rear perspective view of an actuator sleeve of the plug-type connector;

FIG. 8 shows a cross-sectional view of the plug-type connector showing an actuator mounted to the actuator sleeve;

FIG. 9 shows a right side perspective view of the plug-type connector, with the actuator sleeve removed;

FIG. 10 shows a left side perspective view of the plug-type connector, with the actuator sleeve removed;

FIG. 11 shows a right side perspective view of the plug-type connector, with a portion of the actuator sleeve cut-away to show the interaction between right cam structures of the core body and the actuator sleeve with a right arm of the actuator;

FIG. 12 shows a left side perspective view of the plug-type connector, with a portion of the actuator sleeve cut-away to show the interaction between left cam structures of the core body and the actuator sleeve with a left arm of the actuator;

FIG. 13 shows a right-side perspective view of a second plug-type connector with a second actuator sleeve;

FIG. 14 shows a right-side perspective view of the second plug-type connector, with the second actuator sleeve spaced from the core body;

FIG. 15 is a longitudinal sectional view of the second actuator sleeve, showing an interior surface of a right side of the second actuator sleeve, wherein a rear sleeve cam structure is joined to the interior surface;

FIG. 16 is a longitudinal sectional view of the second actuator sleeve, showing an interior surface of a left side of the second actuator sleeve, wherein a front sleeve cam structure is joined to the interior surface;

FIG. 17 is a longitudinal sectional view of an interior of the right side of the second plug-type connector, showing the interaction of the rear sleeve cam structure with a rear core body cam structure;

FIG. 18 is a longitudinal sectional view of an interior of the left side of the second plug-type connector, showing the interaction of the front sleeve cam structure with a front core body cam structure; and

FIG. 19 is a schematic perspective view of a third plug-type connector.

### DETAILED DESCRIPTION OF ILLUSTRATIVE EMBODIMENTS

It should be noted that in the detailed description that follows, identical components have the same reference numerals, regardless of whether they are shown in different embodiments of the present disclosure. It should also be noted that for purposes of clarity and conciseness, the drawings may not necessarily be to scale and certain features of the disclosure may be shown in somewhat schematic form.

Spatially relative terms, such as “top”, “bottom”, “lower”, “above”, “upper”, and the like, are used herein merely for ease of description to describe one element or feature's relationship to another element(s) or feature(s) as they are illustrated in (a) drawing figure(s) being referred to. It will be understood that the spatially relative terms are not meant to be limiting and are intended to encompass different orientations of the device in use or operation in addition to the orientation depicted in the drawings.

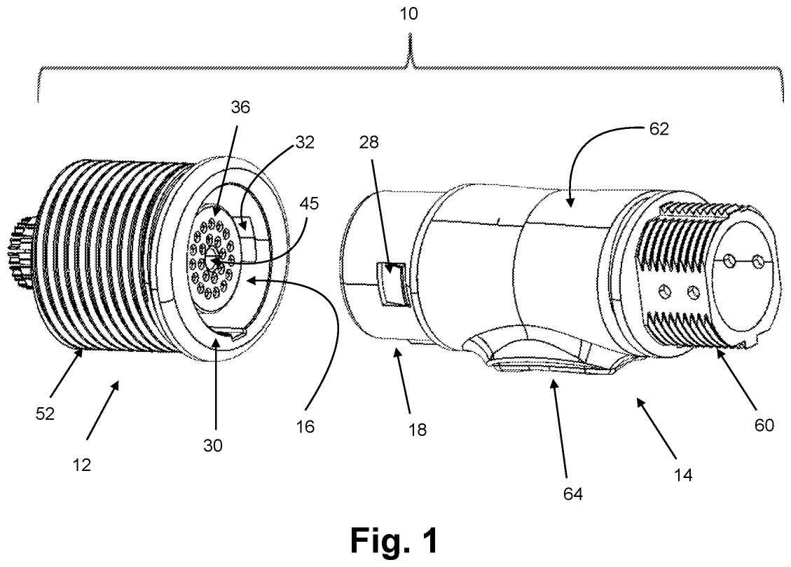

Referring now to FIG. 1, there is shown a connector assembly 10 that generally includes a connector 12 and a connector 14. The connector 12 may have a receptacle 16 configured to receive a plug 18 of the connector 14. The plug 18 has openings 22 through which movable latches or detents 28 may extend, respectively. The receptacle 16 is defined by an inner surface of a support body 30 having a pair of openings or depressions 32 formed therein for receiving the detents 28, respectively, to releasably secure the plug 18 inside the receptacle 16. The support body 30 of the receptacle 16 and the plug 18 may have complementary shapes or configurations to facilitate snug receipt of the plug 18 in the receptacle 16. Thus, if the plug 18 is cylindrical (as shown), the support body 30 may be cylindrical (as shown), with the diameter of the support body 30 being slightly larger than the diameter of the plug 18 to permit the snug receipt of the plug 18 in the receptacle 16. Of course, the plug 18 and the support body 30 may have different complementary shapes or configurations, such as elliptical or rectangular.

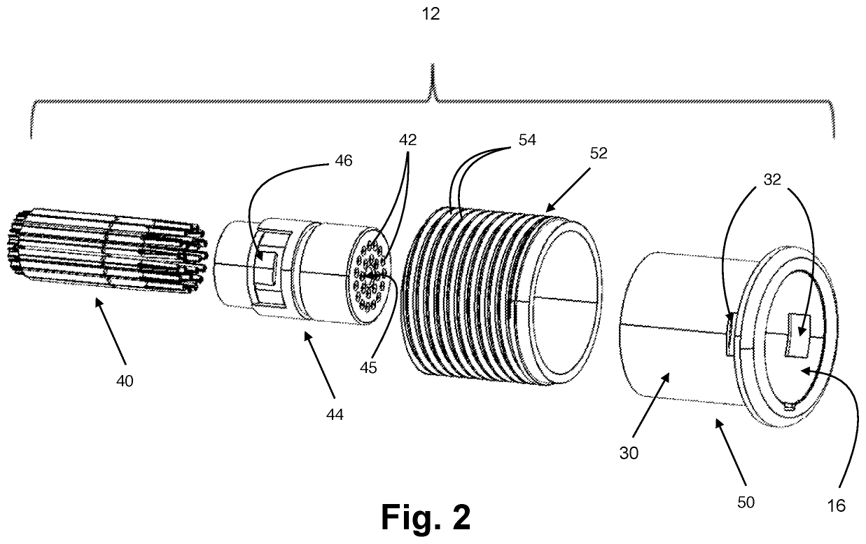

With reference now also to FIG. 2, the connector 12 further includes a first conveyance structure 36 that connects with a second conveyance structure 38 in the connector 14 to convey power (mechanical or electrical) or information signals (electrical or photonic) or fluids (e.g., air, water, oil, etc.) between the connector 12 and the connector 14. For example, the first and second conveyance structures 36, 38 may interconnect to form a mechanical coupling, a fiber optic coupling, a fluidic coupling or an electrical coupling (for power or information signals). In the shown embodiment, the first and second conveyance structures 36, 38 convey electrical signals and, as such, each include one or more electrical conductors. More specifically, the first conveyance structure 36 is an electrical connector that includes a plurality of elongated terminals 40, each of which may have a front male portion and a posterior female portion. The terminals 40 are mounted in a series of passages 42 extending through an insulating structure 44. The insulating structure 44 is composed of an insulating plastic, with a center bore 45 around which the passages are arranged. The insulating structure 44 may include resiliently-deflectable mounting tabs 46 that are engageable with structures joined to the support body 30. The first conveyance structure 36 is mounted to the support body 30 by being inserted into a front portion of the receptacle 16 until the mounting tabs 46 are deflected and then spring back to engage the structures on the inside of the support body 30, thereby securing the first conveyance structure 36 inside the receptacle 16. When so mounted, a posterior end of the conveyance structure 36 is spaced inward from a posterior opening in the receptacle 16 through which the plug 18 is inserted.

A mounting sleeve 52 is disposed over, and supported on, the support body 30 and may be secured thereto by adhesive, vibration welding, mechanical or other securement means. The mounting sleeve 52 includes engagement features 54 for securing the connector 12 to another structure. As shown, the engagement features 54 may be raised ridges or helical threads for engaging the interior surface of a bore of a support structure. If they are helical threads, they may threadably engage threads in the bore; and if they are ridges, they may engage annular grooves or other features inside the bore. Of course, the engagement features 54 may be structures other than ridges or threads in other embodiments. For example, the features may be latches, snap-fits, wedges, etc. It should also be appreciated that instead of having a separate mounting sleeve 52 and support body 30, a single monolithic structure may be provided that both defines the receptacle 16 and has the engagement features 54.

Referring now to FIGS. 1, 3 and 4, the connector 14 generally includes the plug 18, the second conveyance structure 38, one or more spring structures 58, a core body 60 and an actuator sleeve 62 with an actuator 64. As will described below in more detail, in other embodiments, an actuator sleeve 150 or an actuator sleeve 180 may be used in lieu of the actuator sleeve 62 and the actuator 64.

The core body 60 defines an inner chamber 65. The core body 60 includes a plug region 66, a sleeve region 68 and a mounting region 70, which are serially arranged along the longitudinal axis of the core body 60, beginning with a front end of the core body 60 and continuing to a posterior end of the core body 60. The plug region 66 is disposed radially inward from and supports the plug 18. Adjoining the plug region 66 is a front portion of the sleeve region 68, which is disposed radially inward from and supports the actuator sleeve 62. As will be described more fully below, an outside surface of the sleeve region 68 has projecting cam structures 72, 73, 74 for engaging the actuator 64 and the cam structures on the actuator sleeve 62, 150, 180. The cam structures 72, 74 are located on a first or right side of the sleeve region 68, with the cam structure 72 being located toward the front thereof and the cam structure 74 being located toward the rear thereof. The cam structure 73 is located on a second or left side of the sleeve region 68, toward the front thereof. Adjoining a rear portion of the sleeve region 68 is an annular flange 76, which separates the mounting region 70 from the sleeve region 68. The mounting region 70 includes engagement features 80 for securing the connector 14 to another structure. As shown, the engagement features 80 may be raised ridges that engage annular grooves or other features inside a bore of the structure. Of course, the engagement features 80 may be structures other than ridges in other embodiments. For example, the features may be helical threads, latches, snap-fits, wedges, etc.

The second conveyance structure 38 is disposed inside the inner chamber 65 of the core body 60 and may be releasably secured therein. The second conveyance structure 38 is an electrical connector and has a structure similar to the first conveyance structure 36. The second conveyance structure 38 includes a plurality of terminals 82, each of which may be elongated and have a front male portion and a posterior female portion. The male portions of the terminals 82 are configured to be received in the female portions of the terminals 40 to thereby establish electrical connections between the first and second conveyance structures 36, 38. The terminals 82 are mounted in a series of passages extending through an insulating structure 84. The insulating structure 84 is composed of an insulating plastic and may have a front end face with a guide post 86 extending therefrom. The male portions of the terminals 82 project outwardly from the front end face and are arranged around the guide post 86. When the second conveyance structure 38 is being connected to the first conveyance structure 36, the insertion of the guide post 86 into the center bore 45 of the first conveyance structure 36 helps guide the front male portions of the terminals 82 into the passages 42 and engagement with the female portions of the terminals 40. The insulating structure 84 may include resiliently-deflectable mounting tabs 88 that are engageable with structures joined to an interior of the core body 60.

It should be appreciated that in other embodiments, the first and second conveyance structures 36, 38 may have different constructions, depending on what is being conveyed and the specific application of the connector assembly 10. For example, in some embodiments involving an electrical connection, the insulating structure 84 and the guide post 86 may not be present. In some of these embodiments, the first and second conveyance structures 36, 38 may, by way of further example, each have a single electrical contact or terminal, wherein the terminals are connected together to convey power between the connectors 12, 14.

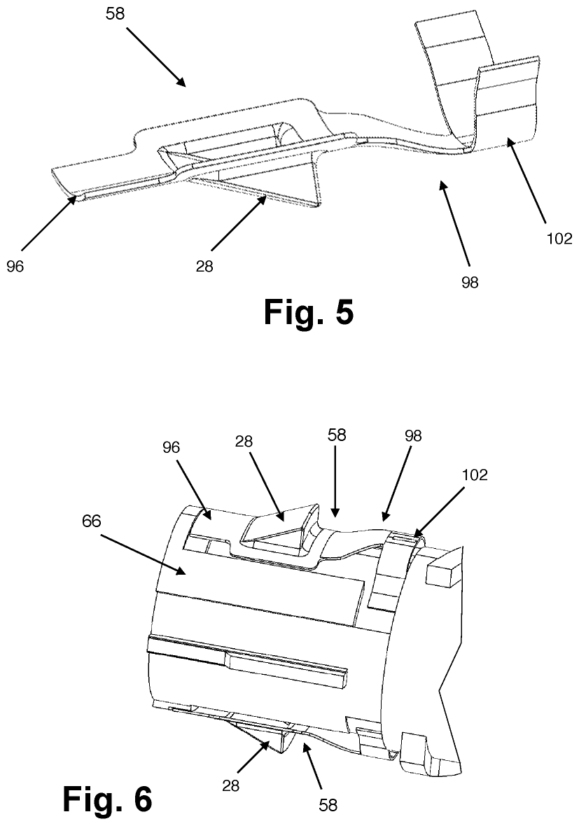

With particular reference to FIGS. 5 and 6, the one or more spring structures 58 may each be a monolithic or unitary clip structure comprised of a flexible material, such as a flexible plastic or thin metal. In other embodiments, however, the spring structures 58 may not be separate structures and may, instead, be integral components of the core body 60. Each spring structure 58 includes a detent 28 connected between a front anchor portion 96 and a rear spring portion 98. The anchor portions 96 may be slightly arcuate, while the detents 28 may be wedge-shaped. The spring portions 98 each include a generally U-shaped bracket 102. The spring structures 58 are disposed over opposing sides of the plug region 66 of the core body 60 such that the detents 28 project outwardly and the brackets 102 straddle portions of the plug region 66. The spring portions 98 bias the detents 28 outwardly, away from the core body 60 and toward an engaged position. When the brackets 102 are pressed inwardly, toward the core body 60, the spring portions 98 move the detents 28 inwardly, toward the core body 60 and a disengaged position. The spring structures 58 are held in position by the plug 18, which is disposed over the plug region 66 so as to trap the anchor portions 96 of the spring structures 58 between the plug region 66 and the plug 18.

In other embodiments, the one or more spring structures 58 may each comprise a spherical or ball-shaped detent 28 that is biased by a helical or other type of spring toward the engaged position. The spring and at least a portion of the detent 28 may be held in a cavity or socket of the core body 60, with an outer portion of the detent 28 projecting outward from the socket when the detent 28 is in the engaged position.

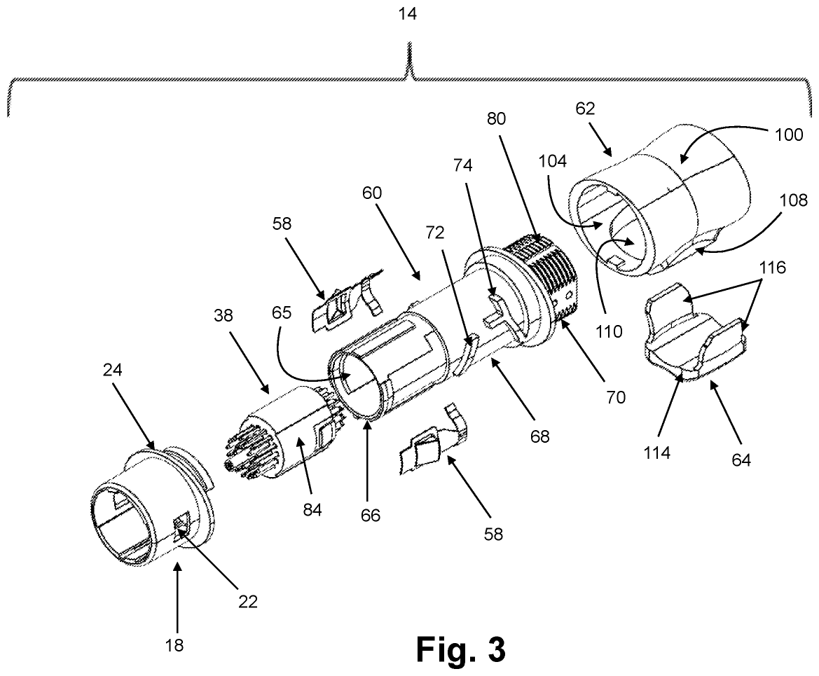

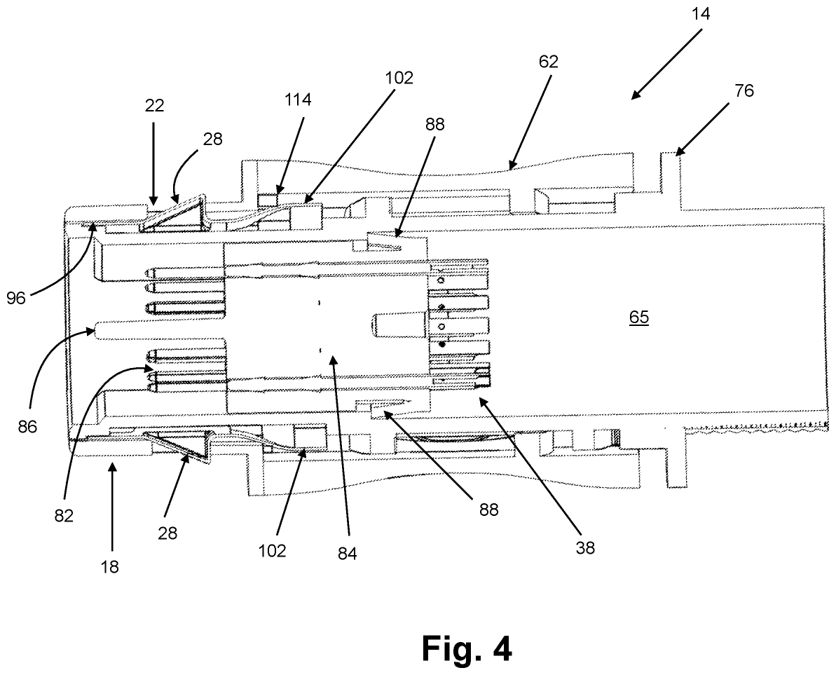

Referring back to FIGS. 3 and 4, the plug 18 has open ends. As set forth above, the plug 18 has openings 22 in its side wall through which the detents 28 may extend. An annular flange 24 is joined to the side wall at a posterior end of the plug 18.

In one embodiment, the plug 18 may be constructed to be linearly movable over the plug region 66 of the core body 60, between a connecting position and a disconnecting position, by moving the actuator sleeve 62. In the connecting position, a front edge of the plug 18 is aligned with a front edge of the core body 60 and the openings 22 are aligned with the detents 28, respectively, such that the detents 28 extend through the openings 22 and are in their engaged positions. In the disconnecting position, the front edge of the plug 18 is disposed rearward from the front edge of the core body 60 and the detents 28 are not aligned with the openings 22. Instead, the detents 28 are at least partially disposed under front portions of the plug 18 and are in their disengaged positions. When the plug 18 is moved rearwardly from the connecting position to the disconnecting position, front edges of the plug 18 that help define the openings 22 engage the sloping surfaces of the detents 28 and push the detents 28 inwardly (against the biases of the spring portions 98) so as to permit them to move under the front portions of the plug 18 and into their disengaged positions.

In other embodiments, the detents 28 may be moved from their engaged positions to their disengaged positions by means other than moving the plug 18, as will be described more fully below.

When the plug 18 of the connector 14 is pushed or otherwise inserted into the receptacle 16 of the connector 12, the support body 30 of the connector 12 depresses the detents 28 (to move them to their disengaged positions) until the detents 28 reach the openings 32, at which point they spring back to their engaged positions and enter the openings 32, thereby connecting the connectors 12, 14. Thus, when the connector 14 is connected to the connector 12, the plug 18 is disposed in the receptacle 16 of the connector 12, with the detents 28 being held in the openings 32 of the support body 30. When the detents 28 are moved from their engaged positions to their disengaged positions, the detents 28 are retracted from the openings 32, thereby allowing the plug assembly 14 to be disconnected from the connector 12.

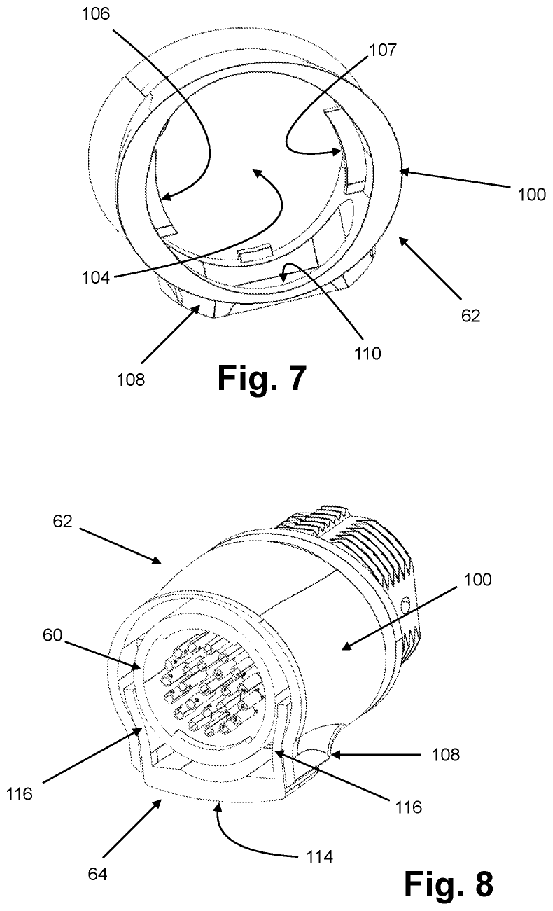

Referring now also to FIGS. 7 and 8, the actuator sleeve 62 has open ends and includes a side wall 100. An inner surface of the side wall 100 defines a passage 104 that extends longitudinally through the actuator sleeve 62. A pair of rear cam structures 106, 107 are joined to the inner surface, inside the passage 104, and protrude radially inward. A mount 108 with an enlarged opening 110 is formed in the side wall 100. The opening 110 provides access to the passage 104. The actuator 64 is mounted to the actuator sleeve 62 so as to extend into the opening 110.

The actuator sleeve 62 is disposed over the core body 60 so as to be positioned between the annular flanges 24, 76. The actuator sleeve 62 is movable linearly relative to the core body 60 in response to manual manipulation of a user. More specifically, the actuator sleeve 62 may be linearly moved between first and second linear positions. When the actuator sleeve 62 is in the second linear position, the actuator sleeve 62 abuts the annular flange 76. If the plug 18 is not moveable, the actuator sleeve 62 will be proximate to the annular flange 24 when the actuator sleeve 62 is in the first linear position and will be distal to the annular flange 24 when the actuator sleeve 62 is in the second linear position.

In the embodiment where the plug 18 is moveable, the plug 18 is connected to the actuator sleeve 62 so as to be moveable therewith, with the first and second linear positions of the actuator sleeve 62 corresponding to the connecting position and the disconnecting position of the plug 18. More specifically, moving the actuator sleeve 62 from the first linear position to the second linear position, moves the plug 18 from the connecting position to the disconnecting position.

In addition to being linearly moveable, the actuator sleeve 62 may be angularly moveable relative to the core body 60 in response to manual manipulation of a user. More specifically, the actuator sleeve 62 may be rotatable between a first angular position and a second angular position. In such an embodiment, rotating the actuator sleeve 62 from the first angular position to the second angular position, may move a pair of forward cam structures (not shown) into engagement with the spring portions 98 of the spring structures 58 such that the forward cam structures press the brackets 102 inwardly, toward the core body 60, thereby moving the detents 28 inwardly, to their disengaged positions.

It should be appreciated that constructing the connector 14 to have the actuator sleeve 62 be rotatable may be simpler if the plug 18 is not connected to the actuator sleeve 62 so as to be moveable therewith. As such, it may be preferred if the plug 18 is not connected to the actuators sleeve 62 when the actuator sleeve 62 is made rotatable.

Referring now to FIGS. 8-12, the actuator 64 includes a pushbutton 114 having a pair of actuator arms 116 extending therefrom. The actuator arms 116 are resiliently deflectable toward and away from each other and have outer free end portions 118 that bend outwardly. This configuration permits the actuator arms 116 to be inserted into the opening 110 such that the free end portions 118 are disposed above (as viewed in FIG. 8) and extend radially outward from pinch points formed at the base of the mount 108. In this manner, the actuator 64 is held in the opening 110 and is biased downward (as viewed in FIG. 8) so as to be in an extended position. As described below, the pushbutton 114 may be actuated (pressed inward) so as to move the actuator 64 to a retracted position. With the actuator 64 so mounted to the actuator sleeve 62, the pushbutton 114 and the actuator arms 116 are in close proximity to an inner surface of the mount 108.

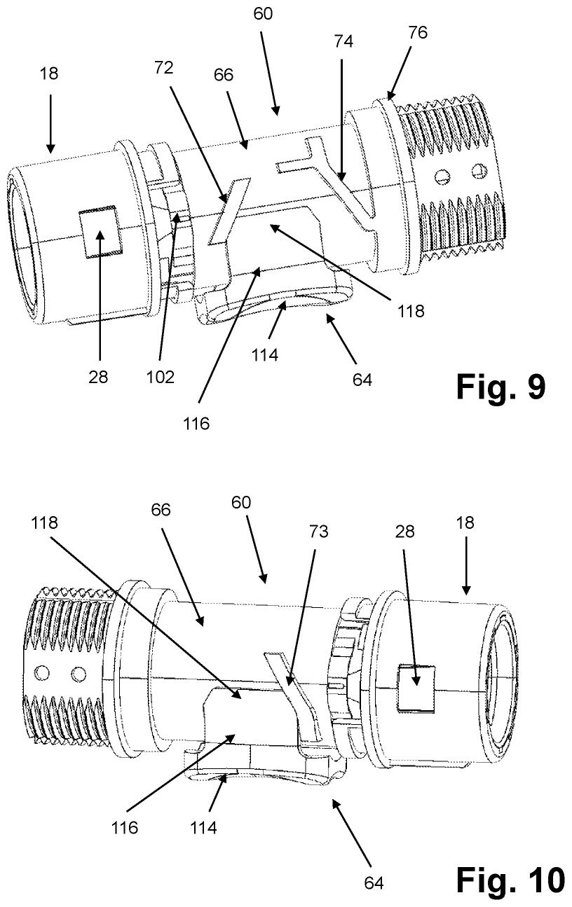

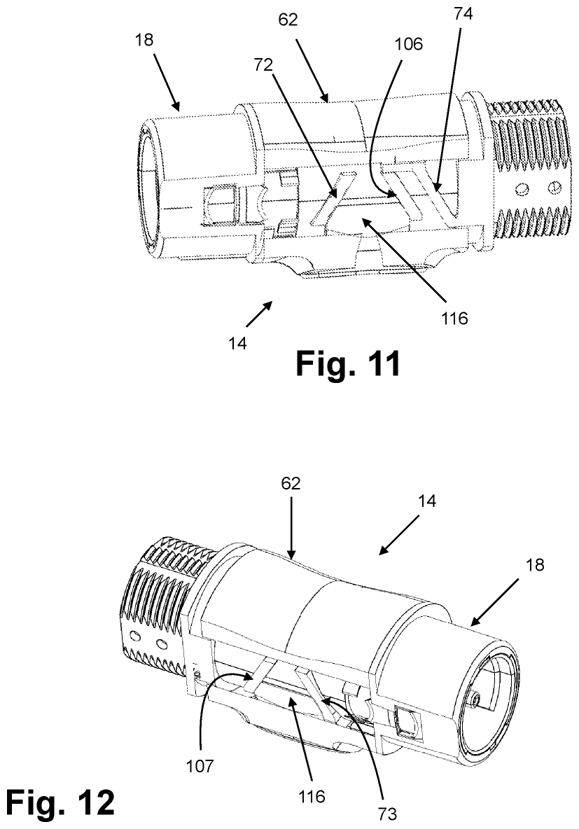

As best shown, in FIGS. 9-10, the free end portions 118 of the actuator arms 116 have tapered edges, which are configured to engage the cam structures 72, 73 of the core body 60 and the rear cam structures 106, 107 of the actuator sleeve 62. As shown in FIGS. 9-12, the cam structures 72, 73 of the core body 60 slope upwardly and rearwardly, toward the mounting region 70 of the core body 60, while the rear cam structures 106, 107 of the actuator sleeve 62 slope upwardly and forwardly, toward the plug 18. As best shown in FIGS. 11 and 12, when the actuator 64 is in the extended position (as shown), forward tapered edges of the free end portions 118 abut inner portions of the cam structures 72, 73 of the core body 60, respectively, and rearward tapered edges of the free end portions 118 abut inner portions of the rear cam structures 106, 107 of the actuator sleeve 62. When the pushbutton 114 is pressed inward by a user, toward the retracted position, the front tapered edges of the free end portions 118 slide over the inner portions of the cam structures 72, 73, which applies rearward forces to the free end portions 118, causing the free end portions 118 (as well as the rest of the actuator 64) to move rearward. As the free end portions 118 move rearward, the rear tapered edges of the free end portions 118 slide over the inner portions of the rear cam structures 106, 107, which apply rearward forces to the actuator sleeve 62, causing the actuator sleeve 62 to move rearward. Any upward forces applied to the actuator sleeve 62 are constrained by the sliding engagement of an upper end portion of the rear cam structure 106 with a longitudinal portion of the cam structure 74. An angled portion of the cam structure 74 stops rearward motion of the rear cam structures 106, 107 and, thus rearward motion of the actuator sleeve 62. In this regard, the cam structure 74 acts as a guide with regard to the actuator sleeve 62.

In the foregoing manner, moving the actuator 64 from the extended position to the retracted position, linearly moves the actuator sleeve 62 from the first linear position to the second linear position. In turn, the movement of the actuator sleeve 62 from the first linear position to the second linear position moves the detents 28 from their engaged positions to their disengaged positions. This may be accomplished by connecting the plug 18 to the actuator sleeve 62 so that the plug 18 moves when the actuator sleeve 62 moves, as described above. In addition to or in lieu of this interconnection, the actuator sleeve 62 may be constructed to press the brackets 102 inwardly, toward the core body 60, thereby moving the detents 28 inwardly, to their disengaged positions. For example, as shown in FIG. 4, the actuator sleeve 62 may include engagement structures 114 joined to an interior surface of the actuator sleeve 62. These engagement structures 114 depress the brackets 102 when the actuator sleeve 62 is moved rearward to the second linear position.

In the drawings, the plug 18, the support body 30, the core body 60 and the actuator sleeve 62 are shown as being at least generally cylindrical and having at least generally cylindrical surfaces that fit into, receive, slide over or otherwise engage with each other. It should be appreciated, however, that the present invention is in no way limited to having components with such cylindrical configurations and engagement surfaces. Indeed, the plug 18, the support body 30, the core body 60, the actuator sleeve 62 and their engagement surfaces may be elliptical, rectangular, or any other desired shape.

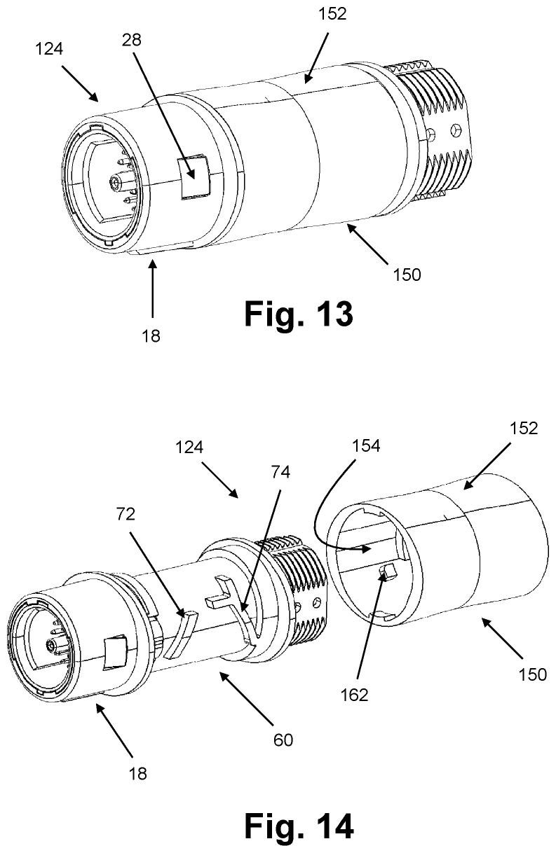

As set forth above, an actuator sleeve 150 may be used in lieu of the actuator sleeve 62. FIGS. 13 and 14, show a connector 124, which may have the same construction as the connector 14, except the actuator sleeve 150 is mounted to the core body 60 instead of the actuator sleeve 62.

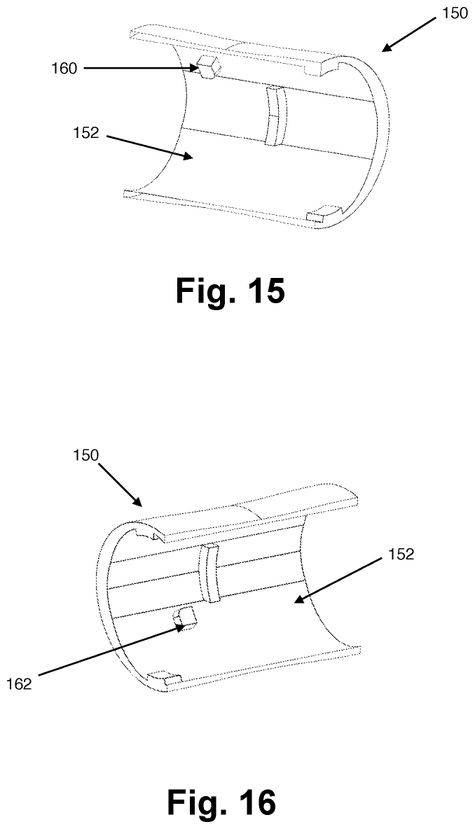

Referring now to FIGS. 13-16, the actuator sleeve 150 has open ends and includes a side wall 152. An inner surface of the side wall 152 defines a passage 154 that extends longitudinally through the actuator sleeve 150. Cam structures 160, 162 are joined to the inner surface of the side wall 152 and protrude inwardly therefrom. The cam structure 160 is located on a first or right side of the actuator sleeve 150, toward the rear of the actuator sleeve 150, while the cam structure 162 is located on a second or left side of the actuator sleeve 150, toward the front of the actuator sleeve 150. Unlike the actuator sleeve 62, the actuator sleeve 150 does not have an enlarged opening for mounting an actuator.

The actuator sleeve 150 is disposed over the core body 60 so as to be positioned between the annular flanges 24, 76. The actuator sleeve 150 is movable both linearly and angularly relative to the core body 60 in response to manual manipulation of a user. More specifically, the actuator sleeve 150 may be linearly moved between first and second linear positions and may be angularly moved between first and second angular positions. Both the linear movement of the actuator sleeve 150 from the first linear position to the second linear position and the angular movement of the actuator sleeve 150 from the first angular position to the second angular position moves the detents 28 from their engaged positions to their disengaged positions.

Similar to the connector 14, the connector 124 may be constructed to have the plug 18 connected to the actuator sleeve 150 so as to linearly move with the actuator sleeve 150, or the plug 18 may be fixed and not moveable with the actuator sleeve 150.

The movement of the detents 28 from their engaged positions to their disengaged positions that is achieved by the linear movement of the actuator sleeve 150 from the first linear position to the second linear position, may be accomplished by connecting the plug 18 to the actuator sleeve 150 so that the plug 18 moves when the actuator sleeve 150 moves, such as described above with regard to the connector 14. In addition to or in lieu of this interconnection, the actuator sleeve 150 may be constructed to press the brackets 102 inwardly, toward the core body 60, thereby moving the detents 28 inwardly, to their disengaged positions. For example, the actuator sleeve 150 may include engagement structures 114, such as in the actuator sleeve 62. These engagement structures 114 depress the brackets 102 when the actuator sleeve 150 is moved rearward to the second linear position.

The movement of the detents 28 from their engaged positions to their disengaged positions that is achieved by the angular movement of the actuator sleeve 150 from the first angular position to the second angular position, may be accomplished by the engagement of cam structures (such as the front cam structures described above with the connector 14) with the spring portions 98 of the spring structures 58 such that the cam structures press the brackets 102 inwardly, toward the core body 60, thereby moving the detents 28 inwardly, to their disengaged positions. Alternately, the detents 28 may be moved using the cam structures 160, 162 joined to the inner surface of the side wall 152 of the actuator sleeve 150, which interact with the cam structures 73, 74 of the core body 60, as described more fully below.

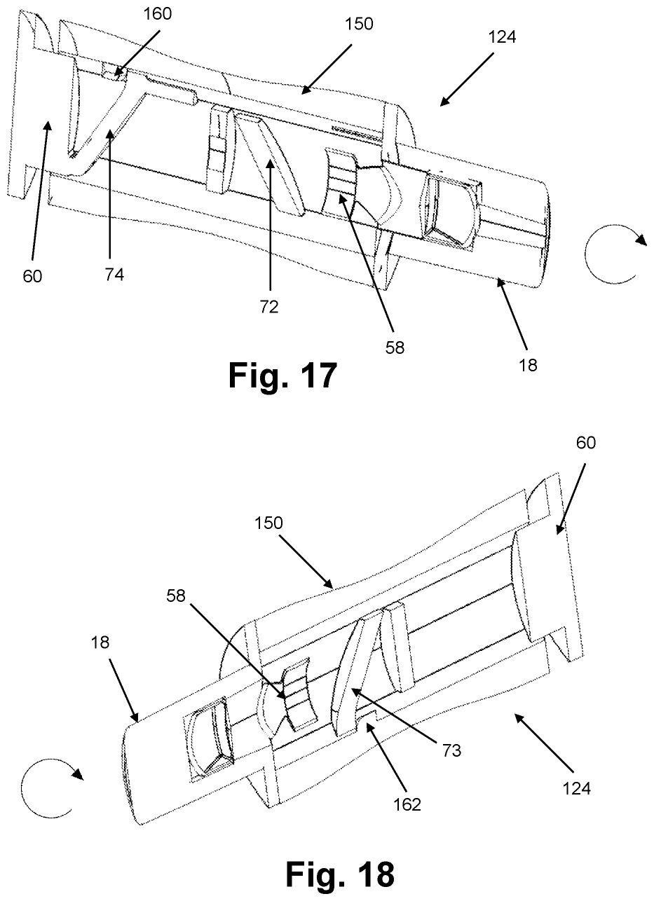

When the actuator sleeve 150 is rotated clockwise (as indicated in FIGS. 17 and 18), the cam structure 162 of the actuator sleeve 150 slides over (in an upwardly and rearwardly direction in FIG. 18) an inner surface of the cam structure 73, which applies a rearward force to the cam structure 162 and, thus, the actuator sleeve 150, causing the actuator sleeve 150 to move rearward. In addition, the cam structure 160 slides over (in a downwardly and rearwardly direction in FIG. 17) an outer surface of the angled portion of the cam structure 74, which applies a rearward force to the cam structure 160 and, thus, the actuator sleeve 150, also causing the actuator sleeve 150 to move rearward.

In the foregoing manner, rotating the actuator sleeve 150 (clockwise) from the first angular position to the second angular position, linearly moves the actuator sleeve 150 from the first linear position to the second linear position. In turn, the movement of the actuator sleeve 150 from the first linear position to the second linear position moves the detents 28 from their engaged positions to their disengaged positions. This may be accomplished by connecting the plug 18 to the actuator sleeve 150 so that the plug 18 moves when the actuator sleeve 150 moves, as described above with regard to the connector 14. In addition to or in lieu of this interconnection, the actuator sleeve 150 may be constructed to press the brackets 102 inwardly, toward the core body 60, thereby moving the detents 28 inwardly, to their disengaged positions.

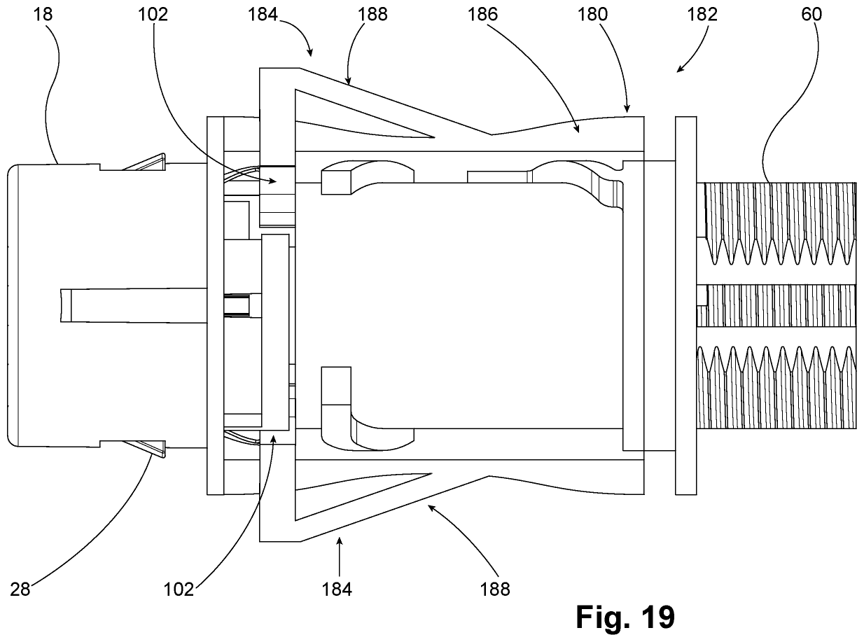

As set forth above, an actuator sleeve 180 may be used in lieu of the actuator sleeve 62 (or actuator sleeve 150). FIG. 19, shows a connector 182, which may have the same construction as the connector 14, except the actuator sleeve 180 is mounted to the core body 62 instead of the actuator sleeve 62.

The actuator sleeve 180 may have the same construction as the actuator sleeve 150, except the actuator sleeve 180 has a pair of pinch actuators 184 operably mounted to opposing sides of a side wall 186. In addition, the side wall 186 has openings that are aligned over the brackets 102 of the spring structures 58, respectively. The pinch actuators 184 may each include a lever 188 mounted to a rear portion of the side wall 186 in cantilever fashion. Front ends of the levers 188 may be joined to actuator blocks 190, respectively, which are aligned with the openings in the side wall 184 disposed over the brackets 102. Each lever 188 may be resiliently moveable relative to the side wall 184 so as to move its actuator block 190 between an outward position, wherein the actuator block 190 is spaced from its corresponding bracket 102, and an inward position, wherein the actuator block 190 extends through its corresponding opening and presses the bracket 102 inward. The levers 188 bias the actuator blocks 190 toward the outward positions. Pinching the levers 188 toward each other so as to move the actuator blocks 190 to the inward positions, presses the brackets 102 inward, which moves the detents 28 from their engaged positions to their disengaged positions.

The actuator sleeve 180 may have the features (e.g., cams 160, 162) of the actuator sleeve 150 that permit it to be movable both linearly and angularly relative to the core body 60 in response to manual manipulation of a user, wherein the linear and angular movement of the actuator sleeve 180 moves the detents 28 from their engaged positions to their disengaged positions.

It should be appreciated from the foregoing description that a plurality of different connectors (14, 124, 182) may be constructed from a core set of common or universal components (18, 38, 58, 60), with only a limited number of unique components being required for each different connector. For example, the connector 14 only requires unique components 62, 64; the connector 124 only requires the unique component 150; and the connector 182 only requires the unique component 180. The use of a core set of shared components to manufacture different connectors, allows a manufacturer to reduce its inventory of components and simplify its design of different connectors.

It is to be understood that the description of the foregoing exemplary embodiment(s) is (are) intended to be only illustrative, rather than exhaustive. Those of ordinary skill will be able to make certain additions, deletions, and/or modifications to the embodiment(s) of the disclosed subject matter without departing from the spirit of the disclosure or its scope.

1. A connector assembly for connecting together parts to convey movement of a medium between the parts, the connector assembly comprising:
a first connector having a receptacle containing a first conveyance device constructed to convey movement of the medium; and
a second connector for connection to the first connector and comprising:
a plug for receipt in the receptacle of the first connector;
a core body having an inner chamber;
a second conveyance device mounted in the chamber of the core body, the second conveyance device being constructed to convey movement of the medium and being configured for connection to the first conveyance device;
a fastener having an engagement portion moveable between an engaged position and a disengaged position to connect and disconnect the first and second connectors, respectively, the fastener being at least partially supported by the core body; and
a sleeve disposed over the core body, wherein the sleeve is linearly moveable between first and second linear positions and is angularly moveable between first and second angular positions, and wherein linear movement of the sleeve from the first linear position to the second linear position and angular movement of the sleeve from the first angular position to the second angular position moves the engagement portion of the fastener from the engaged position to the disengaged position, to thereby disconnect the first and second connectors.

2. The connector assembly of claim 1, wherein the plug is disposed over the core body and has an opening through which the engagement portion of the fastener extends when the engagement portion is in the engaged position.

3. The connector assembly of claim 2, wherein the plug is moveable over the core body between a connecting position and a disconnecting position to connect and disconnect the first and second connectors, respectively.

4. The connector assembly of claim 3, wherein the plug is linearly movable between the connecting position and the disconnecting position; and wherein the plug is connected to the sleeve so as to move when the sleeve moves.

5. (canceled)

6. The connector assembly of claim 4, wherein rotating the sleeve from the first angular position to the second angular position linearly moves the sleeve from the first linear position to the second linear position, which, in turn, moves the plug from the connecting position to the disconnecting position.

7. The connector assembly of claim 6, wherein the engagement portion of the fastener is a detent, wherein when the plug moves from the connecting position to the disconnecting position, a contacting portion of the plug contacts the detent and moves the detent to the disengaged position, and wherein the detent is wedge-shaped.

8. The connector assembly of claim 1, further comprising an actuator that is moveable relative to the core body to move the engagement portion of the fastener from the engaged position to the disengaged position.

9. The connector assembly of claim 8, wherein the actuator is mounted to the sleeve, wherein the sleeve is linearly moveable in a first direction and the actuator is at least partially linearly moveable in a second direction, and wherein the second direction is perpendicular to the first direction.

10. The connector assembly of claim 9, wherein the actuator comprises a pushbutton with a pair of arms extending therefrom, wherein the core body has at least one cam surface, and wherein depressing the pushbutton moves the arms into contact with the at least one cam surface of the core body, thereby linearly moving the sleeve to move the engagement portion of the fastener from the engaged position to the disengaged position.

11. The connector assembly of claim 1, wherein the engagement portion of the fastener is a detent, and wherein the fastener is a spring structure in which the detent is connected to a spring portion that biases the detent toward the engaged position.

12. The connector assembly of claim 11, wherein compression of the spring portion moves the detent to the disengaged position.

13. The connector assembly of claim 12, wherein when the sleeve is moved from the first linear position to the second linear position, the sleeve compresses the spring portion of the spring structure.

14. The connector assembly of claim 13, wherein an interior of the sleeve has a first cam surface, wherein an exterior of the core body has a second cam surface, and wherein when the sleeve is rotated from the first angular position to the second angular position, the first cam surface engages the second cam surface to thereby move the sleeve from the first linear position to the second linear position.

15. The connector assembly of claim 1, wherein the medium is electric current and the first and second conveyance devices are electrical connectors for conveying electric current;
wherein the first connector comprises a support body having an inner surface defining the receptacle for receiving the plug of the second connector, the inner surface of the support body having an opening or depression for receiving therein the engagement portion of the fastener to releasably secure the plug inside the receptacle; and
wherein when the plug of the second connector is releasably secured inside the receptacle of the first connector, the first and second conveyance devices are physically and electrically connected together to permit current to flow between the first and second connectors.

16. A connector assembly for connecting together parts to convey movement of a medium between the parts, the connector assembly comprising:
a first connector comprising a first conveyance device constructed to convey movement of the medium; and
a second connector for connection to the first connector and comprising:
a core body having an inner chamber;
a second conveyance device mounted in the chamber of the core body, the second conveyance device being constructed to convey movement of the medium and being configured for connection to the first conveyance device;
a fastener having an engagement portion moveable between an engaged position and a disengaged position to connect and disconnect the first and second connectors, respectively, the engagement portion being at least partially supported by the core body; and
a first release apparatus having a sleeve disposed over the core body and moveable relative to the core body to move the engagement portion of the fastener from the engaged position to the disengaged position; and
a second release apparatus having an actuator that is moveable relative to the core body to move the engagement portion of the fastener from the engaged position to the disengaged position.

17. The connector assembly of claim 16, wherein the actuator is mounted to the sleeve, wherein the sleeve is moveable in a first direction and the actuator is at least partially moveable in a second direction, and wherein the second direction is perpendicular to the first direction.

18. The connector assembly of claim 17, wherein the actuator comprises a pushbutton with a pair of arms extending therefrom, wherein the core body has at least one cam surface, and wherein depressing the pushbutton moves the arms into contact with the at least one cam surface of the core body, thereby moving the sleeve to move the engagement portion of the fastener from the engaged position to the disengaged position.

19. The connector assembly of claim 17, wherein the fastener is a first fastener, the second connector further comprises a second fastener and wherein each of the first and second fasteners comprises a spring structure in which an engagement portion is connected to a spring portion that biases the engagement portion toward the engaged position, and wherein compression of the spring portion moves the engagement portion to the disengaged position.

20. The connector assembly of claim 19, wherein the actuator is movable inward to compress the spring portions of the spring structures and thereby move the engagement portions of the spring structures to the disengaged positions.

21. The connector assembly of claim 20, wherein the actuator comprises a pair of levers pivotally mounted to the sleeve to be movable inward to compress the spring portions of the spring structures and thereby move the engagement portions of the spring structures to the disengaged position for disconnecting the first and second connectors.

22. The connector assembly of claim 16, wherein the medium is electric current and the first and second conveyance devices are electrical connectors for conveying electric current;
wherein the second connector further comprises a plug that is disposed over the core body and has an opening through which the engagement portion of the fastener extends when the engagement portion is in the engaged position;
wherein the first connector comprises a support body having an inner surface defining a receptacle for receiving the plug of the second connector, the inner surface of the support body having an opening or depression for receiving therein the engagement portion of the fastener to releasably secure the plug inside the receptacle; and
wherein when the plug of the second connector is releasably secured inside the receptacle of the first connector, the first and second conveyance devices are physically and electrically connected together to permit current to flow between the first and second connectors.

23. The connector assembly of claim 9, wherein the fastener is a first fastener, the second connector comprises a second fastener and wherein each of the first and second fasteners comprises a spring structure in which an engagement portion is connected to a spring portion that biases the engagement portion toward the engaged position, and wherein compression of the spring portion moves the engagement portion to the disengaged position; and
wherein the actuator comprises a pair of levers pivotally mounted to the sleeve to be movable inward to compress the spring portions of the spring structures and thereby move the engagement portions of the spring structures to the disengaged position for disconnecting the first and second connectors.
